(19) United States
(12) Patent Application Publication
(10) Pub. No.: US 2026/0254390 A1
(43) Pub. Date: Aug. 27, 2026

(54) CONTROL DEVICE

(71) Applicant: KABUSHIKI KAISHA TOYOTA JIDOSHOKKI, Kariya-shi, Aichi (JP)

(72) Inventors: Kazuki ASAHINA, Aichi (JP); Akira IDE, Aichi (JP); Kiyoshi UETSUJI, Aichi (JP); Shinji DOKI, Aichi (JP); Rongjiao HAO, Aichi (JP)

(73) Assignee: KABUSHIKI KAISHA TOYOTA JIDOSHOKKI, Kariya-shi, Aichi (JP)

(21) Appl. No.: 19/160,256

(22) PCT Filed: Feb. 16, 2024
(86) PCT No.: PCT/JP2024/005617

§ 371 Date: Aug. 27, 2025

(30) Foreign Application Priority Data
Feb. 28, 2023 (JP) 2023-029506

(51) Int. Cl. H02P 27/06; H02P 23/14

(52) U.S. Cl. CPC H02P 27/06; H02P 23/14

(57) ABSTRACT

A control device includes: a drive signal output unit that outputs a drive signal to an inverter; and an estimation unit that calculates an estimated extended electromotive force generated in a motor based on a γ-axis current value, a δ-axis current value, a γ-axis voltage command value, and a δ-axis voltage command value, and calculates an estimated position of the motor based on the estimated extended electromotive force. The drive signal output unit generates an upper arm short-circuit drive signal or a lower arm short-circuit drive signal when a restart request is received or when it is determined that the motor is rotating at a low speed. The estimation unit calculates the estimated position based on the γ-axis current value and the δ-axis current value converted from the current flowing through the motor by the upper arm short-circuit drive signal or the lower arm short-circuit drive signal.

### TECHNICAL FIELD

The present disclosure relates to a control device.

### BACKGROUND ART

A position sensorless control of a motor using an extended electromotive force is known. For example, Non-Patent Document 1 describes a restart algorithm which estimates an excited extended electromotive force by setting a current command value to 0 for a certain period of time immediately after restarting from a free-run state, performs position estimation and polarity determination in a stop low-speed region where the extended electromotive force is insufficient, and performs position estimation without signal superposition in a medium-to-high-speed region where the extended electromotive force is sufficient.

### CITATION LIST

### Non Patent Literature

Non-Patent Document 1: Takamasa Kozakura, Shinji Doki, “Examinations about Restart from Free-run State in Position Sensorless Control of Permanent Magnet Synchronous Motor with Extended ElectroMotive Force”, The Papers of Joint Meeting on “Motor Drive”, “Rotating Machinery”, and “Vehicle Technology”, IEE Japan, Japan, The Institute of Electrical Engineers of Japan, May 30, 2021, p. 63-68

### SUMMARY OF INVENTION

### Technical Problem

The position estimation method described in Non-Patent Document 1 is not capable of estimating a position with high accuracy under all conditions, and a proposal of a different position estimation method is desired.

The present disclosure describes a control device capable of improving the accuracy of position estimation.

### Solution to Problem

A control device according to one aspect of the present disclosure is a control device that generates a drive signal for controlling an inverter that drives a motor. The control device includes: a current value conversion unit that converts a current flowing through the motor into a γ-axis current value and a δ-axis current value; a γ-δ current command value output unit that outputs a γ-axis current command value and a δ-axis current command value; a γ-δ voltage command value calculation unit that calculates a γ-axis voltage command value and a δ-axis voltage command value based on the γ-axis current value, the γ-axis current command value, the δ-axis current value, and the δ-axis current command value; a drive signal output unit that converts the γ-axis voltage command value and the δ-axis voltage command value into the drive signal and outputs the drive signal to the inverter; and an estimation unit that calculates an estimated extended electromotive force, which is an estimated value of an extended electromotive force generated in the motor, based on the γ-axis current value, the δ-axis current value, the γ-axis voltage command value, and the δ-axis voltage command value, and calculates an estimated position, which is an estimated value of a position of the motor, based on the estimated extended electromotive force. The drive signal output unit generates, when a restart request is received or when it is determined that the motor is rotating at a low speed, an upper arm short-circuit drive signal, which is the drive signal that simultaneously turns on switching elements of upper arms of three phases in the inverter and simultaneously turns off switching elements of lower arms of the three phases in the inverter, or a lower arm short-circuit drive signal, which is the drive signal that simultaneously turns off the switching elements of the upper arms of the three phases in the inverter and simultaneously turns on the switching elements of the lower arms of the three phases in the inverter. The estimation unit calculates the estimated position based on the γ-axis current value and the δ-axis current value converted from the current flowing through the motor by the upper arm short-circuit drive signal or the lower arm short-circuit drive signal.

When the restart request is received or when it is determined that the motor is rotating at a low speed, the control device simultaneously turns on the switching elements of the upper arms of the three phases in the inverter and simultaneously turns off the switching elements of the lower arms of the three phases in the inverter, or simultaneously turns off the switching elements of the upper arms of the three phases in the inverter and simultaneously turns on the switching elements of the lower arms of the three phases in the inverter. Therefore, since the actual voltage value and the voltage command value can be made zero, the voltage error can be eliminated. As a result, it is possible to improve the accuracy of position estimation.

The estimation unit may calculate the estimated extended electromotive force by Equation (1) described later, in which a γ-axis estimated extended electromotive force is denoted as e^{\hat{ }}_{γ}, a δ-axis estimated extended electromotive force is denoted as e^{\hat{ }}_{δ}, the γ-axis voltage command value is denoted as V*γ, the δ-axis voltage command value is denoted as V*_{δ}, an estimated winding resistance is denoted as R^{\hat{ }}, a d-axis estimated inductance is denoted as L′d, a q-axis estimated inductance is denoted as L′q, an estimated angular velocity is denoted as ω^{\hat{ }}ᵣₑ, the γ-axis current value is denoted as I_{γ}, the δ-axis current value is denoted as I_{δ}, and a differential operator is denoted as p. The estimation unit may calculate the estimated extended electromotive force by setting V*_{γ}=V*_{δ}=0 and ω^{\hat{ }}ᵣₑ=0 in Equation (1) when the restart request is received or when it is determined that the motor is rotating at a low speed. In this case, the calculation of the estimated extended electromotive force can be simplified.

When the restart request is received, the estimation unit may: calculate a first estimated extended electromotive force by setting V*_{γ}=V*_{δ}=0 and ω^{\hat{ }}ᵣₑ=0 in Equation (1); calculate a first estimated position based on the first estimated extended electromotive force; in response to a predetermined time having elapsed from calculating the first estimated position, calculate a second estimated extended electromotive force by setting V*_{γ}=V*_{δ}=0 and ω^{\hat{ }}ᵣₑ=0 in Equation (1); calculate a second estimated position based on the second estimated extended electromotive force; and calculate the estimated angular velocity based on the first estimated position and the second estimated position. In this case, the estimated angular velocity is calculated from the two estimated positions calculated with high accuracy. Therefore, it is possible to improve the calculation accuracy of the estimated angular velocity after the restart.

The drive signal output unit may supply the upper arm short-circuit drive signal or the lower arm short-circuit drive signal to the inverter over a supply period. The estimation unit may calculate the estimated position when a motor current value of the current flowing through the motor becomes equal to or greater than a threshold current value in the supply period. In this case, since the estimated position is calculated when a certain amount of current flows through the motor, the accuracy of the position estimation can be further improved.

The drive signal output unit may extend the supply period in stages when the motor current value is less than the threshold current value in the supply period. In this case, the supply period of the upper arm short-circuit drive signal or the lower arm short-circuit drive signal becomes gradually longer. Therefore, it is possible to allow a certain amount of current to flow through the motor rotating at a low speed while reducing the possibility of an overcurrent occurring in the motor rotating at a high speed. As a result, it is possible to expand the range of the rotational speed of the motor in which the position can be estimated.

A control device according to another aspect of the present disclosure is a control device that generates a drive signal for controlling an inverter that drives a motor. The control device includes: a current value conversion unit that converts a current flowing through the motor into a γ-axis current value and a δ-axis current value; a γ-δ current command value output unit that outputs a γ-axis current command value and a δ-axis current command value; a γ-δ voltage command value calculation unit that calculates a γ-axis voltage command value and a δ-axis voltage command value based on the γ-axis current value, the γ-axis current command value, the δ-axis current value, and the δ-axis current command value; a drive signal output unit that converts the γ-axis voltage command value and the δ-axis voltage command value into the drive signal and outputs the drive signal to the inverter; and an estimation unit that calculates an estimated extended electromotive force, which is an estimated value of an extended electromotive force generated in the motor, based on the γ-axis current value, the δ-axis current value, the γ-axis voltage command value, and the δ-axis voltage command value, calculates an estimated position, which is an estimated value of a position of the motor, based on the estimated extended electromotive force, and calculates an estimated angular velocity of the motor based on the estimated position. The drive signal output unit generates, when a restart request is received, an upper arm short-circuit drive signal, which is the drive signal that simultaneously turns on switching elements of upper arms of three phases in the inverter and simultaneously turns off switching elements of lower arms of the three phases in the inverter, or a lower arm short-circuit drive signal, which is the drive signal that simultaneously turns off the switching elements of the upper arms of the three phases in the inverter and simultaneously turns on the switching elements of the lower arms of the three phases in the inverter. The estimation unit calculates a first estimated position, which is the estimated position, based on the γ-axis current value and the δ-axis current value converted from the current flowing through the motor by the upper arm short-circuit drive signal or the lower arm short-circuit drive signal. The drive signal output unit generates the upper arm short-circuit drive signal or the lower arm short-circuit drive signal again after calculating the first estimated position. The estimation unit calculates a second estimated position, which is the estimated position, based on the γ-axis current value and the δ-axis current value converted from the current flowing through the motor by the upper arm short-circuit drive signal or the lower arm short-circuit drive signal generated again, and calculates the estimated angular velocity based on the first estimated position and the second estimated position.

In the control device, the actual voltage value and the voltage command value can be made zero by simultaneously turning on the switching elements of the upper arms of the three phases in the inverter and simultaneously turning off the switching elements of the lower arms of the three phases in the inverter, or by simultaneously turning off the switching elements of the upper arms of the three phases in the inverter and simultaneously turning on the switching elements of the lower arms of the three phases in the inverter. Therefore, since the voltage error can be eliminated, the first estimated position and the second estimated position can be calculated with high accuracy. Since the estimated angular velocity is calculated from the two estimated positions calculated with high accuracy, it is possible to improve the calculation accuracy of the estimated angular velocity after the restart. As described above, it is possible to improve the accuracy of the position estimation and the accuracy of the angular velocity estimation.

### Advantageous Effects of Invention

According to the present disclosure, the accuracy of position estimation can be improved.

### BRIEF DESCRIPTION OF DRAWINGS

FIG. 1 is a schematic configuration diagram of a control system including a control device according to an embodiment.

FIG. 2 is a block diagram showing a functional configuration of the arithmetic unit shown in FIG. 1.

FIG. 3 is a flowchart showing an example of a restart pre-processing performed by the control device of FIG. 1.

FIG. 4 is a diagram for explaining the accuracy of the estimated extended electromotive force.

FIG. 5 is a flowchart showing an example of an angular velocity estimation processing performed by the control device of FIG. 1.

FIG. 6 is a flowchart showing another example of the restart pre-processing performed by the control device of FIG. 1.

FIG. 7 is a flowchart showing another example of the restart pre-processing performed by the control device of FIG. 1.

FIG. 8 is a diagram showing a relationship between a lower arm short-circuit period and a current flowing through a motor.

### DESCRIPTION OF EMBODIMENTS

Hereinafter, a control device according to an embodiment will be described in detail with reference to the accompanying drawings. In the description of the drawings, the same or equivalent elements are denoted by the same reference numerals, and redundant description will be omitted.

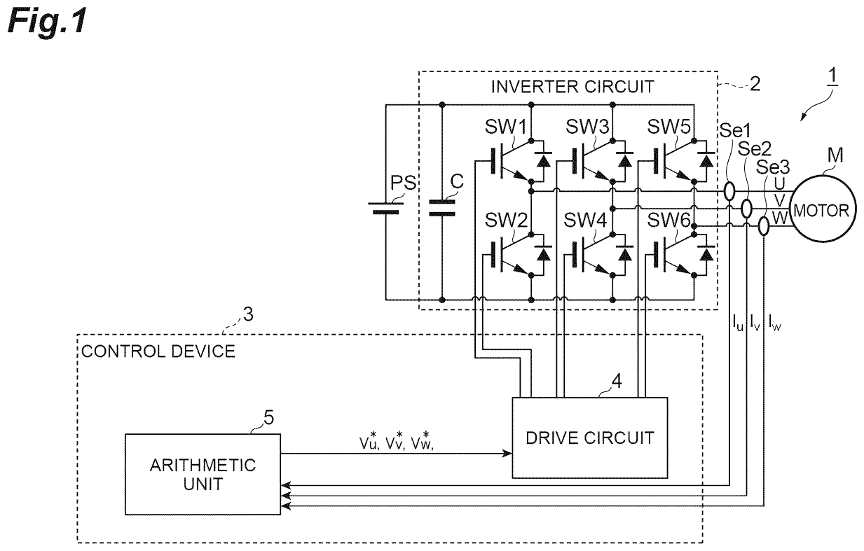

A schematic configuration of a control system including a control device according to an embodiment will be described with reference to FIG. 1. FIG. 1 is a schematic configuration diagram of a control system including a control device according to an embodiment. The control system 1 shown in FIG. 1 is a system that performs position sensorless control of a motor (electric motor) M. The motor M is a position sensorless motor, such as a permanent magnet synchronous motor (PMSM). The motor M is mounted on a vehicle such as an electric forklift and a plug-in hybrid vehicle. The control system 1 includes an inverter circuit 2, a control device 3, and current sensors Se1, Se2, and Se3.

The inverter circuit 2 drives the motor M by the DC power supplied from the DC power supply PS. The inverter circuit 2 includes a capacitor C and switching elements SW1, SW2, SW3, SW4, SW5, and SW6.

The capacitor C smoothes the voltage output from the DC power supply PS and input to the inverter circuit 2.

The switching elements SW1 to SW6 are, for example, insulated gate bipolar transistors (IGBT). The switching element SW1 is a switching element of the U-phase upper arm. The switching element SW2 is a switching element of the U-phase lower arm. The switching element SW3 is a switching element of the V-phase upper arm. The switching element SW4 is a switching element of the V-phase lower arm. The switching element SW5 is a switching element of the W-phase upper arm. The switching element SW6 is a switching element of the W-phase lower arm. One terminal of the capacitor C is connected to the positive terminal of the DC power supply PS and to the collector terminals of the switching elements SW1, SW3, and SW5. The other terminal of the capacitor C is connected to the negative terminal of the DC power supply PS and the emitter terminals of the switching elements SW2, SW4, and SW6.

A connection point between the emitter terminal of the switching element SW1 and the collector terminal of the switching element SW2 is connected to a U-phase input terminal of the motor M, and the current sensor Se1 for detecting a U-phase current value is disposed on the connection line. A connection point between the emitter terminal of the switching element SW3 and the collector terminal of the switching element SW4 is connected to a V-phase input terminal of the motor M, and the current sensor Se2 for detecting a V-phase current value is disposed on the connection line. A connection point between the emitter terminal of the switching element SW5 and the collector terminal of the switching element SW6 is connected to the W-phase input terminal of the motor M, and the current sensor Se3 for detecting a W-phase current value is disposed on the connection line.

A drive signal is supplied from the control device 3 to the gate of each of the switching elements SW1 to SW6. Each of the switching elements SW1 to SW6 is turned on or off based on the drive signal supplied to the gate. By turning each of the switching elements SW1 to SW6 on or off, the DC power supplied from the DC power supply PS is converted into three AC powers having phases differing from each other by 120 degrees, and these AC powers are input to the input terminals of three phases (U phase, V phase, and W phase) of the motor M, thereby causing the rotor of the motor M to rotate.

The current sensors Se1 to Se3 are constituted by Hall elements, shunt resistors, or the like. The current sensor Se1 detects a U-phase current value Iᵤ, which is a current value of the AC current flowing through the U-phase of the motor M, and outputs it to the control device 3. The current sensor Se2 detects a V-phase current value Iᵥ, which is a current value of the AC current flowing through the V-phase of the motor M, and outputs it to the control device 3. The current sensor Se3 detects a W-phase current value I_{w}, which is a current value of the AC current flowing through the W-phase of the motor M, and outputs it to the control device 3. In the present embodiment, the control system 1 includes three current sensors (current sensors Se1 to Se3), but may include two current sensors.

The control device 3 is a device that performs position sensorless control of the motor M. The control device 3 controls the inverter circuit 2 to drive the motor M. The control device 3 includes a drive circuit 4 and an arithmetic unit 5.

The drive circuit 4 is constituted by an integrated circuit (IC) or the like. The drive circuit 4 compares the U-phase voltage command value V*ᵤ, the V-phase voltage command value V*ᵥ, and the W-phase voltage command value V*_{w} output from the arithmetic unit 5 with a carrier wave (a triangular wave, a sawtooth wave, an inverse sawtooth wave, or the like), and outputs a drive signal corresponding to the comparison result to the gate terminal of each of the switching elements SW1 to SW6.

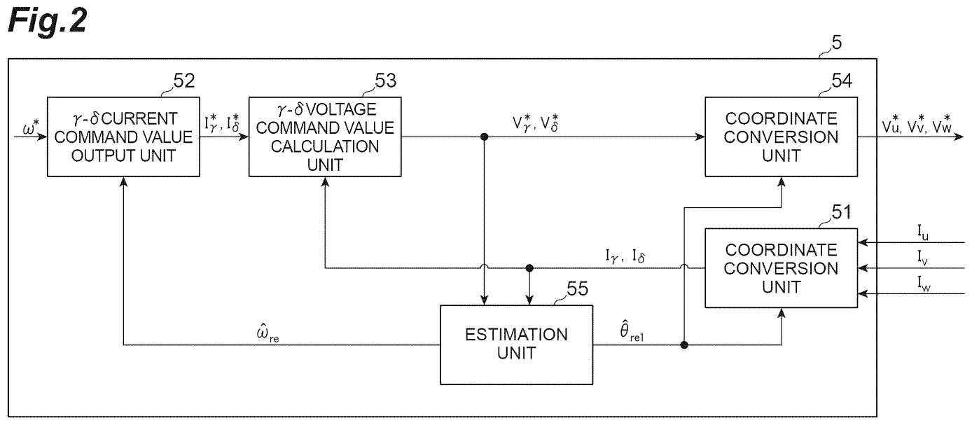

The arithmetic unit 5 is an electronic control unit including a central processing unit (CPU), a read only memory (ROM), a random access memory (memory, RAM), and the like. For example, a program stored in the ROM is loaded onto the RAM and executed by the CPU, thereby realizing various functions of the arithmetic unit 5 shown in FIG. 2.

Next, the functional configuration of the arithmetic unit 5 will be described with reference to FIG. 2. FIG. 2 is a block diagram showing a functional configuration of the arithmetic unit shown in FIG. 1. As shown in FIG. 2, the arithmetic unit 5 includes, as functional elements, a coordinate conversion unit 51, a γ-δ current command value output unit 52, a γ-δ voltage command value calculation unit 53, a coordinate conversion unit 54, and an estimation unit 55.

The coordinate conversion unit 51 converts the U-phase current value Iᵤ, the V-phase current value Iᵥ, and the W-phase current value I_{w} into the γ-axis current value I_{γ} and the δ-axis current value I_{δ} based on the estimated position θ^{\hat{ }}ᵣₑₗ output from the estimation unit 55. That is, the coordinate conversion unit 51 functions as a current value conversion unit that converts the current flowing through the motor M into the γ-axis current value I_{γ} and the δ-axis current value I_{δ}. The estimated position θ^{\hat{ }}ᵣₑₗ is an estimated value of the position θᵣₑₗ of the rotor of the motor M. Since this conversion method is known, a detailed description thereof will be omitted. The coordinate conversion unit 51 outputs the γ-axis current value I_{γ} and the δ-axis current value Is to the γ-δ voltage command value calculation unit 53 and the estimation unit 55. The coordinate conversion unit 51 may receive, as input, the current values of two phases among the U-phase current value Iᵤ, the V-phase current value Iᵥ, and the W-phase current value I_{w}, and calculate the current value of the remaining one phase from the input two phase current values.

In the notation of “θ^{\hat{ }}ᵣₑₗ”, “^{\hat{ }}” is positioned at the upper right of “θ”, but “θ^{\hat{ }}ᵣₑₗ” has the same meaning as the symbol described in the arrow from the estimation unit 55 to the coordinate conversion unit 51 in FIG. 2. The same applies to other notations of “^{\hat{ }}”. In this specification, the symbol “^{\hat{ }}” means an estimated value.

The γ-δ coordinate system is an estimated rotating coordinate system, and is a coordinate system in which the axis corresponding to the d-axis of the d-q coordinate system is defined as the γ-axis and the axis corresponding to the q-axis is defined as the δ-axis. The d-q coordinate system is a rotating coordinate system in which the N pole direction of the magnet of the motor M is defined as a d-axis and a direction orthogonal to the d-axis is defined as a q-axis.

The γ-δ current command value output unit 52 calculates the angular velocity difference Δω between the angular velocity command value ω* input from the outside and the estimated angular velocity ω^{\hat{ }}ᵣₑ output from the estimation unit 55, and calculates a torque command value T* using the angular velocity difference Δω. The estimated angular velocity ω^{\hat{ }}ᵣₑ is an estimated value of the angular velocity ωᵣₑ of the rotor of the motor M. The γ-δ current command value output unit 52 calculates a γ-axis current command value I*_{γ} and a δ-axis current command value I*_{δ} using the torque command value T*. Since a method of generating the γ-axis current command value I*_{γ} and the δ-axis current command value I*_{δ} is known, a detailed description thereof will be omitted. The γ-δ current command value output unit 52 outputs the γ-axis current command value I*_{γ} and the δ-axis current command value I*_{δ} to the γ-δ voltage command value calculation unit 53.

The γ-δ voltage command value calculation unit 53 generates a γ-axis voltage command value V*_{γ} and a δ-axis voltage command value V*_{δ}. The γ-δ voltage command value calculation unit 53 calculates a difference γ-axis current command value ΔI*_{γ} which is the difference between the γ-axis current command value I*_{γ} and the γ-axis current value I_{γ}, calculates a difference δ-axis current command value ΔI*_{δ} which is the difference between the δ-axis current command value I*_{δ} and the δ-axis current value I_{δ}, and converts the difference γ-axis current command value ΔI*_{γ} and the difference δ-axis current command value ΔI*_{δ} into the γ-axis voltage command value V*_{γ} and the δ-axis voltage command value V*_{δ}. That is, the γ-δ voltage command value calculation unit 53 calculates the γ-axis voltage command value V*_{γ}, and the δ-axis voltage command value V*_{δ} based on the γ-axis current command value I*_{γ}, the γ-axis current value I_{γ}, the δ-axis current command value I*_{δ}, and the δ-axis current value I_{δ}. Since a method of generating the γ-axis voltage command value V*_{γ} and the δ-axis voltage command value V*_{δ} is known, a detailed description thereof will be omitted. The γ-δ voltage command value calculation unit 53 outputs the γ-axis voltage command value V*_{γ} and the δ-axis voltage command value V*_{δ} to the coordinate conversion unit 54 and the estimation unit 55.

The coordinate conversion unit 54 converts the γ-axis voltage command value V*_{γ} and the δ-axis voltage command value V*_{δ} into the U-phase voltage command value V*ᵤ, the V-phase voltage command value V*ᵥ, and the W-phase voltage command value V*_{w} based on the estimated position θ^{\hat{ }}ᵣₑₗ output from the estimation unit 55. Since this conversion method is known, a detailed description thereof will be omitted. The coordinate conversion unit 54 outputs the U-phase voltage command value V*ᵤ, the V-phase voltage command value V*ᵥ, and the W-phase voltage command value V*_{w} to the drive circuit 4. That is, the coordinate conversion unit 54 and the drive circuit 4 function as a drive signal output unit that converts the γ-axis voltage command value V*_{γ} and the δ-axis voltage command value V*_{δ} into drive signals and outputs the drive signals to the inverter circuit 2.

The estimation unit 55 calculates the estimated angular velocity ω^{\hat{ }}ᵣₑ and the estimated position θ^{\hat{ }}ᵣₑₗ. The estimation unit 55 calculates an estimated extended electromotive force e^{\hat{ }}, which is an estimated value of an extended electromotive force (EEMF) e generated in the motor M, based on the γ-axis current value I_{γ}, the δ-axis current value Is, the γ-axis voltage command value V*_{γ}, the δ-axis voltage command value V*_{δ}, an estimated angular velocity ω^{\hat{ }}ᵣₑ stored in a memory (not shown), and a motor parameter that can be estimated in advance. That is, it can be said that the estimation unit 55 calculates the estimated extended electromotive force e^{\hat{ }}, which is an estimated value of the extended electromotive force generated in the motor M, based on the γ-axis current value I_{γ}, the δ-axis current value I_{δ}, the γ-axis voltage command value V*_{γ}, and the δ-axis voltage command value V*_{δ}. Specifically, the estimation unit 55 calculates the estimated extended electromotive force e^{\hat{ }} using the observer (motor model) shown in Equation (1). The estimated extended electromotive force e^{\hat{ }} includes a γ-axis estimated extended electromotive force e^{\hat{ }}_{δ} and a δ-axis estimated extended electromotive force e^{\hat{ }}_{δ} as vector components.

$$[ Equation 1 ]$$

$$[ \begin{matrix}{\hat{e}}_{γ} \\ {\hat{e}}_{δ}\end{matrix} ] = [ \begin{matrix}{V}_{γ}^{*} \\ {V}_{δ}^{*}\end{matrix} ] - [ \begin{matrix}\hat{R} + p {\hat{L}}_{d} & {\hat{ω}}_{re} {\hat{L}}_{q} \\ {\hat{ω}}_{re} {\hat{L}}_{q} & \hat{R} + p {\hat{L}}_{d}\end{matrix} ] [ \begin{matrix}{I}_{γ} \\ {I}_{δ}\end{matrix} ] \qquad ( 1 )$$

Note that p represents a time differential operator d/dt. The estimated winding resistance R^{\hat{ }}, the d-axis estimated inductance L^{\hat{ }}_{d}, and the q-axis estimated inductance L^{\hat{ }}_{q} are estimated values of the motor parameters of the motor M to be controlled, and are estimated in advance by measurement using the motor M. The reason why estimated values rather than actual values are used as the motor parameters of the motor M is that the motor parameters fluctuate depending on the current flowing through the motor M and the temperature.

Then, the estimation unit 55 calculates a position error Δθ^{\hat{ }}ᵣₑ based on the estimated extended electromotive force e^{\hat{ }}. Specifically, the estimation unit 55 calculates the position error Δθ^{\hat{ }}ᵣₑ from the estimated extended electromotive force e by Equation (2).

$$[ Equation 2 ]$$

$$Δ {\hat{θ}}_{re} = {tan}^{- 1} ( \frac{- {\hat{e}}_{γ}}{{\hat{e}}_{δ}} ) \qquad ( 2 )$$

Subsequently, the estimation unit 55 calculates the estimated angular velocity ω^{\hat{ }}ᵣₑ based on the position error Δθ^{\hat{ }}ᵣₑ. Specifically, the estimation unit 55 calculates the estimated angular velocity ω^{\hat{ }}ᵣₑ by, for example, multiplying the position error Δθ^{\hat{ }}ᵣₑ by a predetermined transfer function.

Then, the estimation unit 55 calculates the estimated position θ^{\hat{ }}ᵣₑₗ based on the estimated angular velocity ω^{\hat{ }}ᵣₑ and the position error Δθ^{\hat{ }}ᵣₑ. Specifically, for example, the estimation unit 55 calculates the estimated position θ^{\hat{ }}ᵣₑₗ by adding a temporary estimated position θ^{\hat{ }} obtained by integrating the estimated angular velocity ω^{\hat{ }}ᵣₑ and a corrected position error Δθ obtained by multiplying the position error Δθ^{\hat{ }}ᵣₑ by the predetermined transfer function. Although the position error Δθ^{\hat{ }}ᵣₑ is multiplied by the predetermined transfer function, it is not always necessary to multiply the position error Δθ^{\hat{ }}ᵣₑ by the predetermined transfer function. Thereafter, the estimation unit 55 stores the calculated estimated angular velocity ω^{\hat{ }}ᵣₑ and the estimated position θ^{\hat{ }}ᵣₑₗ in the memory, outputs the estimated angular velocity ω^{\hat{ }}ᵣₑ to the γ-δ current command value output unit 52, and outputs the estimated position θ^{\hat{ }}ᵣₑₗ to the coordinate conversion unit 51 and the coordinate conversion unit 54.

Here, when the control device 3 receives a stop request for the motor M from the host device, the control device 3 stops outputting the U-phase voltage command value V*ᵤ, the V-phase voltage command value V*ᵥ, and the W-phase voltage command value V*_{w} without forcibly stopping the motor M. Therefore, the motor M is in a free-run state in which it is rotating by inertia. After that, when the control device 3 receives a restart request for the motor M from the host device, the control device 3 restarts the motor M.

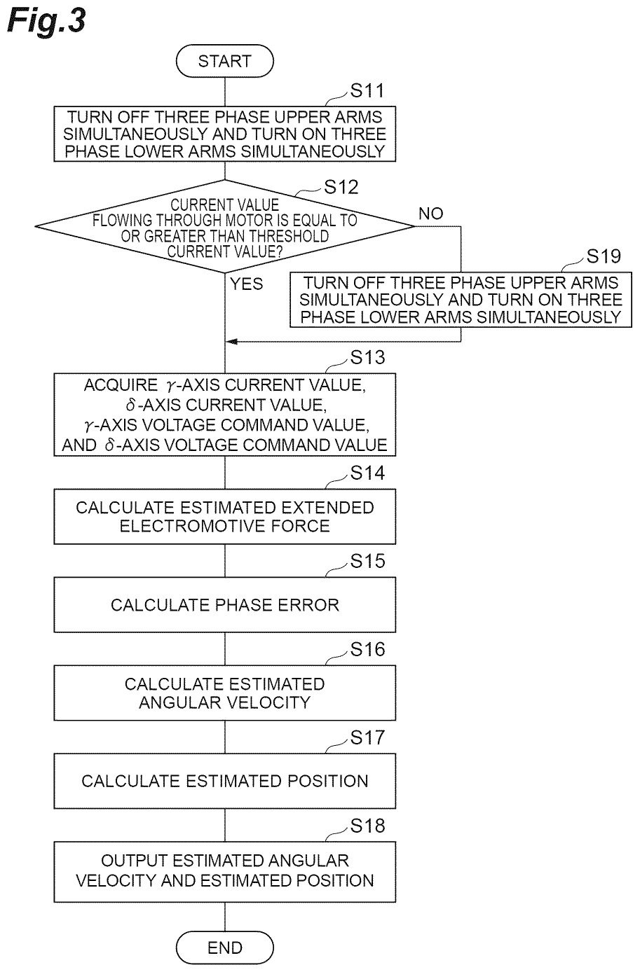

Hereinafter, the restart pre-processing performed by the control device 3 will be described in detail with further reference to FIG. 3. The restart pre-processing is processing performed by the control device 3 after receiving the restart request and before restarting the motor M. FIG. 3 is a flowchart showing an example of a restart pre-processing performed by the control device of FIG. 1. The series of processes shown in FIG. 3 is started in response to the control device 3 receiving a restart request.

As shown in FIG. 3, the control device 3 first controls the switching elements of the upper arms of the three phases included in the inverter circuit 2 to be simultaneously turned off and the switching elements of the lower arms of the three phases to be simultaneously turned on (step S11). This state may be referred to as a “lower arm short-circuit state”, and the period during which the lower arm short-circuit state continues may be referred to as a “lower arm short-circuit period”. Specifically, the coordinate conversion unit 54 causes the drive circuit 4 to output a lower arm short-circuit drive signal, which includes drive signals for simultaneously turning on the switching elements SW2, SW4, and SW6 and turning off the switching elements SW1, SW3, and SW5. The lower arm short-circuit drive signal in step S11 is output for a short period (for example, several μs). Instead of the lower arm short-circuit drive signal, the coordinate conversion unit 54 may cause the drive circuit 4 to output an upper arm short-circuit drive signal which includes drive signals for simultaneously turning on the switching elements SW1, SW3, and SW5 and simultaneously turning off the switching elements SW2, SW4, and SW6.

Subsequently, the arithmetic unit 5 determines whether or not the current value I_{M} (motor current value) flowing through the motor M in response to the lower arm short-circuit drive signal is equal to or greater than the threshold current value Iₜₕ (step S12). The threshold current value Iₜₕ is the minimum value of the current value I_{M} at which the estimated position θ^{\hat{ }}ᵣₑₗ of the motor M can be calculated from the current value I_{M} flowing through the motor M. In other words, when the current value I_{M} flowing through the motor M is less than the threshold current value Iₜₕ, it can be said that the motor M is rotating at an extremely low speed. The current value I_{M} is obtained by, for example, Equation (9). When it is determined in step S12 that the current value I_{M} flowing through the motor M is equal to or greater than the threshold current value Iₜₕ (step S12: YES), the estimation unit 55 acquires the γ-axis current value I_{γ}, the δ-axis current value Is, the γ-axis voltage command value V*_{γ}, and the δ-axis voltage command value V*_{δ} based on the current value I_{M} flowing through the motor M in step S11 (step S13).

Then, the estimation unit 55 calculates the estimated extended electromotive force e^{\hat{ }} using the estimated angular velocity ω^{\hat{ }}ᵣₑ stored in the memory (step S14). Here, it is assumed that when the control device 3 receives the stop request, the estimated angular velocity ω^{\hat{ }}ᵣₑ and the estimated position θ^{\hat{ }}ᵣₑₗ stored in the memory are reset to zero. Therefore, immediately after the control device 3 receives the restart request, the estimated angular velocity ω^{\hat{ }}ᵣₑ is zero. The γ-axis voltage command value V*_{γ} and the δ-axis voltage command value V*_{δ} are both zero because the switching elements of the upper arms of three phases are simultaneously turned off and the switching elements of the lower arms of three phases are simultaneously turned on in step S13.

Therefore, Equation (3) is obtained by substituting V*_{γ}=V*_{δ}=0 and ω^{\hat{ }}ᵣₑ=0 into Equation (1). The estimation unit 55 calculates the estimated extended electromotive force e^{\hat{ }} using the observer (motor model) shown in Equation (3). That is, when the estimation unit 55 receives the restart request, the estimation unit 55 calculates the estimated extended electromotive force e^{\hat{ }} by setting V*_{γ}=V*_{δ}=0 and ωᵣₑ=0 in Equation (1).

$$[ Equation 3 ]$$

$$[ \begin{matrix}{\hat{e}}_{γ} \\ {\hat{e}}_{δ}\end{matrix} ] = - [ \begin{matrix}\hat{R} + p {\hat{L}}_{d} & 0 \\ 0 & \hat{R} + p {\hat{L}}_{d}\end{matrix} ] [ \begin{matrix}{I}_{γ} \\ {I}_{δ}\end{matrix} ] \qquad ( 3 )$$

Subsequently, the estimation unit 55 calculates the position error Δθ^{\hat{ }}ᵣₑ (step S15). In step S15, the estimation unit 55 calculates the position error Δθ^{\hat{ }}ᵣₑ using Equation (2). Then, the estimation unit 55 calculates the estimated angular velocity ω^{\hat{ }}ᵣₑ (step S16). In step S16, the estimation unit 55 calculates the estimated angular velocity ω^{\hat{ }}ᵣₑ by multiplying the position error Δθ re by the predetermined transfer function.

Subsequently, the estimation unit 55 calculates the estimated position θ^{\hat{ }}ᵣₑₗ (step S17). In step S17, the estimation unit 55 calculates the estimated position θ^{\hat{ }}ᵣₑₗ by adding the temporary estimated position θ^{\hat{ }} obtained by integrating the estimated angular velocity ω^{\hat{ }}ᵣₑ and the corrected position error Δθ obtained by multiplying the position error Δθ^{\hat{ }}ᵣₑ by the predetermined transfer function. Then, the estimation unit 55 stores the estimated angular velocity ω^{\hat{ }}ᵣₑ calculated in step S16 and the estimated position θ^{\hat{ }}ᵣₑₗ calculated in step S17 in the memory, outputs the estimated angular velocity ω^{\hat{ }}ᵣₑ to the γ-δ current command value output unit 52, and outputs the estimated position θ^{\hat{ }}ᵣₑₗ to the coordinate conversion unit 51 and the coordinate conversion unit 54 (step S18). Thus, the restart pre-processing is completed.

On the other hand, when it is determined in step S12 that the current value I_{M} flowing through the motor M is less than the threshold current value Iₜₕ (step S12: NO), the coordinate conversion unit 54 again controls the switching elements of the upper arms of the three phases included in the inverter circuit 2 so as to be turned off simultaneously and the switching elements of the lower arms of the three phases so as to be turned on simultaneously (step S19), and then proceeds to step S13. The lower arm short-circuit drive signal in step S19 is output for a longer period (for example, several ms) than the lower arm short-circuit drive signal in step S11. In step S19, the coordinate conversion unit 54 may cause the drive circuit 4 to output the upper arm short-circuit drive signal instead of the lower arm short-circuit drive signal.

In step S13 after step S19, the estimation unit 55 acquires the γ-axis current value I_{γ}, the δ-axis current value I_{δ}, the γ-axis voltage command value V*_{γ}, and the δ-axis voltage command value V*_{δ} based on the current value I_{M} flowing through the motor M in step S19. Thereafter, steps S14 to S18 are executed.

Thus, the series of processes shown in FIG. 3 is completed.

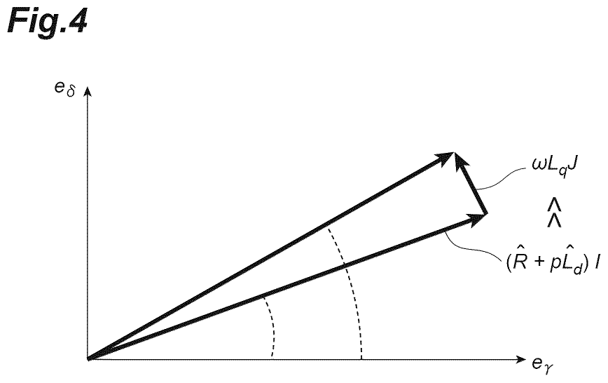

Next, the accuracy of the estimated extended electromotive force e^{\hat{ }} according to Equation (3) will be described with reference to FIG. 4. FIG. 4 is a diagram for explaining the accuracy of the estimated extended electromotive force.

The estimation error Δe^{\hat{ }} is expressed by Equation (4). The estimation error Δe^{\hat{ }} is the difference between the estimated extended electromotive force e and the actual extended electromotive force e. The estimation error Δe^{\hat{ }} includes a γ-axis error Δe^{\hat{ }}_{γ} and a δ-axis error Δe^{\hat{ }}_{δ} as vector components. The error ΔV_{γ} is the difference between the γ-axis voltage command value V*_{γ} and the actual γ-axis voltage. The error ΔV_{δ} is the difference between the δ-axis voltage command value V*_{δ} and the actual δ-axis voltage. The error ΔR is the difference between the estimated winding resistance R^{\hat{ }} and the actual winding resistance R. The error ΔL_{d} is the difference between the d-axis estimated inductance L^{\hat{ }}_{d} and the actual d-axis inductance L_{d}. The error ΔL_{q} is the difference between the q-axis estimated inductance L^{\hat{ }}_{q} and the actual q-axis inductance L_{q}.

$$[ Equation 4 ]$$

$$[ \begin{matrix}Δ {\hat{e}}_{γ} \\ Δ {\hat{e}}_{δ}\end{matrix} ] = [ \begin{matrix}Δ {V}_{γ} \\ Δ {V}_{δ}\end{matrix} ] + [ \begin{matrix}Δ R + p ( Δ {L}_{d} ) & - ( {ω}_{re} {L}_{q} - {\hat{ω}}_{re} {\hat{L}}_{q} ) \\ {ω}_{re} {L}_{q} - {ω}_{re} {\hat{L}}_{q} & Δ R + p ( Δ {L}_{d} )\end{matrix} ] [ \begin{matrix}{I}_{γ} \\ {I}_{δ}\end{matrix} ] \qquad ( 4 )$$

For example, when the processing of step S11 or step S19 is performed, both the γ-axis voltage command value V*_{γ} and the actual γ-axis voltage are zero, and both the δ-axis voltage command value V*_{δ} and the actual δ-axis voltage are zero. Therefore, the errors ΔV_{γ} and ΔV_{δ} become zero. As described above, the estimated angular velocity ω^{\hat{ }}ᵣₑ is zero. Assuming that there is no error in the motor parameters (i.e., the errors ΔR, ΔL_{d}, and ΔL_{q} are zero), Equation (5) holds.

$$[ Equation 5 ]$$

$$[ \begin{matrix}Δ {\hat{e}}_{γ} \\ Δ {\hat{e}}_{δ}\end{matrix} ] = [ \begin{matrix}0 & - {ω}_{re} {L}_{q} \\ {ω}_{re} {L}_{q} & 0\end{matrix} ] [ \begin{matrix}{I}_{γ} \\ {I}_{δ}\end{matrix} ] \qquad ( 5 )$$

The vector diagram of FIG. 4 is obtained by expressing Equations (3) and (5) by vectors. Here, the matrix on the left side of the right-hand side of Equation (3) is expressed as (R^{\hat{ }}+pL^{\hat{ }}_{d}) I using the identity matrix I. The matrix on the left side of the right-hand side of Equation (5) is expressed as ωᵣₑL_{q}J using the alternating matrix J. In the case where a current of a magnitude capable of estimating the position flows through the motor M during the restart pre-processing, the current flowing through the motor M rapidly increases, and the current differential term pL^{\hat{ }}_{d}I becomes dominant, so that the relationship of Equation (6) holds.

$$[ Equation 6 ]$$

$$( R + {pL}_{d} ) I ≫ {ω}_{re} {L}_{q} I \qquad ( 6 )$$

Therefore, since the estimation error Δe^{\hat{ }} is relatively small, it can be said that the estimated extended electromotive force e is calculated with high accuracy. Even when the processing of step S19 is performed, the error ΔV_{γ} and the error ΔV_{δ} can be made zero, so that it can be said that the estimated extended electromotive force e can be calculated with high accuracy.

In the control device 3 described above, when the restart request is received, the estimated extended electromotive force e^{\hat{ }} is calculated with the γ-axis voltage command value V*_{γ} and the δ-axis voltage command value V*_{δ} set to zero, and the estimated position θ^{\hat{ }}ᵣₑₗ is calculated based on the estimated extended electromotive force e^{\hat{ }}. Therefore, since the actual voltage value and the voltage command value can be made zero, the voltage error can be eliminated, and the accuracy of the position estimation can be improved. In particular, when the current value I_{M} flowing through the motor M is less than the threshold current value Iₜₕ, that is, when the motor M is rotating at a low speed, the S/N ratio deteriorates, which may result in a decrease in the accuracy of position estimation. However, by eliminating the voltage error, it is possible to improve the accuracy of position estimation even when the motor M is rotating at a low speed.

In the above embodiments, in the restart pre-processing, the estimation unit 55 calculates the estimated angular velocity ω^{\hat{ }}ᵣₑ based on the estimated extended electromotive force e when the estimated angular velocity ω^{\hat{ }}ᵣₑ is set to zero, and stores the estimated angular velocity ω^{\hat{ }}ᵣₑ in the memory. Accordingly, the estimated extended electromotive force e^{\hat{ }} at the time of restart is calculated using the estimated angular velocity ω^{\hat{ }}ᵣₑ calculated based on the estimated extended electromotive force e^{\hat{ }} when the estimated angular velocity ω^{\hat{ }}ᵣₑ is set to zero, but the estimation unit 55 may calculate the estimated angular velocity ω^{\hat{ }}ᵣₑ in the restart pre-processing.

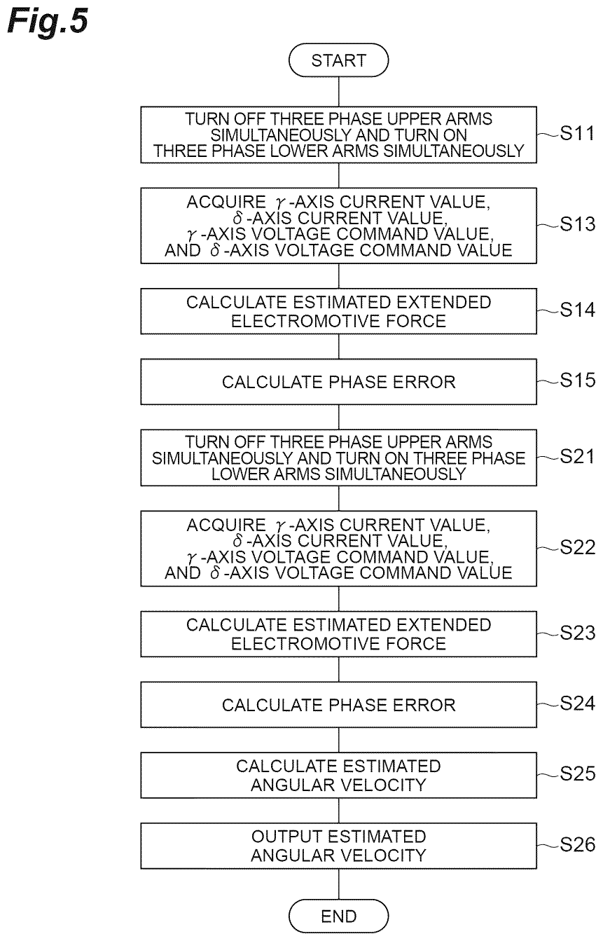

The angular velocity estimation processing performed by the control device 3 will be described in detail with reference to FIG. 5. FIG. 5 is a flowchart showing an example of an angular velocity estimation processing performed by the control device of FIG. 1. In FIG. 5, steps similar to those in the flowchart of FIG. 2 are denoted by the same step numbers, and the description thereof may be partially omitted in the following description.

As shown in FIG. 5, after executing step S11, the control device 3 executes steps S13 to S15 to calculate the position error Δθ^{\hat{ }}ᵣₑ. The position error Δθ^{\hat{ }}ᵣₑ calculated in step S15 is referred to as “first estimated position θ^{\hat{ }}ᵣₑ₂₁”. The first estimated position θ^{\hat{ }}ᵣₑ₂₁ is calculated based on the first estimated extended electromotive force e calculated as V*_{γ}=V*_{δ}=0 and ω^{\hat{ }}ᵣₑ=0 in Equation (1).

Subsequently, after a predetermined time ΔT has elapsed, the process proceeds to step S21. In step S21, the coordinate conversion unit 54 again controls the switching elements of the upper arms of the three phases included in the inverter circuit 2 to be simultaneously turned off and the switching elements of the lower arms of the three phases to be simultaneously turned on. The lower arm short-circuit drive signal in step S21 is output for a very short period (for example, several μs), similarly to step S11. The coordinate conversion unit 54 may cause the drive circuit 4 to output the upper arm short-circuit drive signal instead of the lower arm short-circuit drive signal.

Subsequently, the estimation unit 55 acquires the γ-axis current value I_{γ}, the δ-axis current value I_{δ}, the γ-axis voltage command value V*_{γ}, and the δ-axis voltage command value V*_{δ} based on the current value I_{M} flowing through the motor M in step S21 (step S22). Since step S22 is the same as step S13, a description thereof will be omitted. Thereafter, steps S23 and S24, which are the same as steps S14 and S15, are executed to calculate the position error Δθ^{\hat{ }}ᵣₑ. The position error Δθ^{\hat{ }}ᵣₑ calculated in step S24 is referred to as “second estimated position θ^{\hat{ }}ᵣₑ₂₂”. The second estimated position θ^{\hat{ }}ᵣₑ₂₂ is calculated based on the second estimated extended electromotive force e calculated as V*_{γ}=V*_{δ}=0 and ω^{\hat{ }}ᵣₑ=0 in Equation (1).

Subsequently, the estimation unit 55 calculates the estimated angular velocity ω^{\hat{ }}ᵣₑ (step S25). In step S25, the estimation unit 55 calculates the estimated angular velocity ω^{\hat{ }}ᵣₑ based on the first estimated position θ^{\hat{ }}ᵣₑ₂₁ and the second estimated position θ^{\hat{ }}ᵣₑ₂₂. Specifically, the estimation unit 55 calculates the estimated angular velocity ω^{\hat{ }}ᵣₑ by dividing the subtraction result obtained by subtracting the first estimated position θ^{\hat{ }}ᵣₑ₂₁ from the second estimated position θ^{\hat{ }}ᵣₑ₂₂ by the predetermined time ΔT, as shown in Equation (7).

$$[ Equation 7 ]$$

$${\hat{ω}}_{re} = \frac{{\hat{θ}}_{re 22} - {\hat{θ}}_{re 21}}{Δ T} \qquad ( 7 )$$

Then, the estimation unit 55 stores the estimated angular velocity ω^{\hat{ }}ᵣₑ calculated in step S25 in the memory and outputs the estimated angular velocity ω^{\hat{ }}ᵣₑ to the γ-δ current command value output unit 52 (step S26). Thus, the angular velocity estimation processing is completed. It can be said that both the first estimated position θ^{\hat{ }}ᵣₑ₂₁ and the second estimated position θ^{\hat{ }}ᵣₑ₂₂ are estimated values of the position of the motor M calculated based on the estimated extended electromotive force e^{\hat{ }}.

In the method shown in FIG. 5, the estimated angular velocity ω^{\hat{ }}ᵣₑ can be calculated faster than the estimated angular velocity ω^{\hat{ }}ᵣₑ by executing steps S16 and S17. In addition, it is possible to calculate the estimated extended electromotive force e^{\hat{ }} with higher estimation accuracy than in the case where the estimated extended electromotive force e at the time of restart is calculated using the estimated angular velocity ω^{\hat{ }}ᵣₑ calculated based on the estimated extended electromotive force e^{\hat{ }} when the estimated angular velocity ω^{\hat{ }}ᵣₑ is set to zero, and it is possible to improve the accuracy of position estimation.

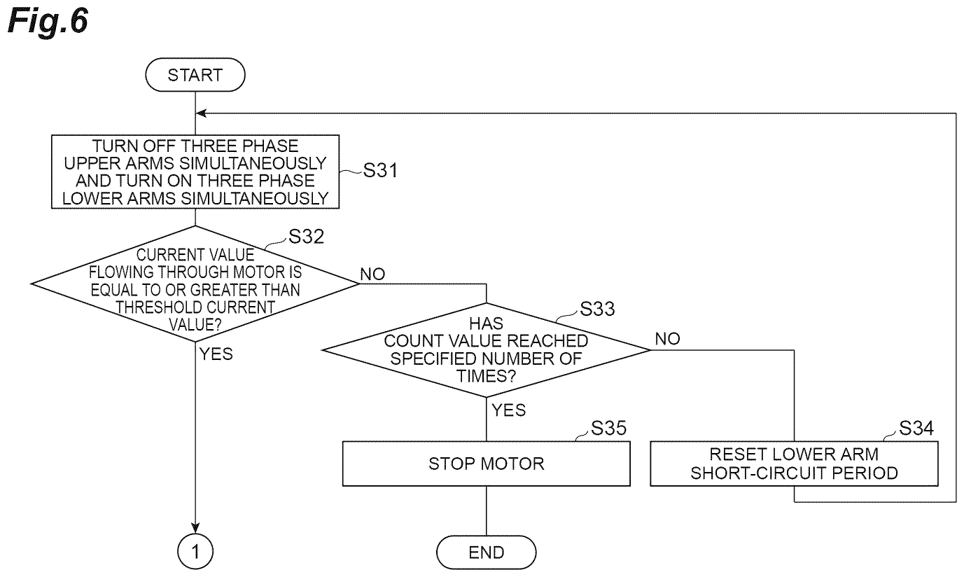

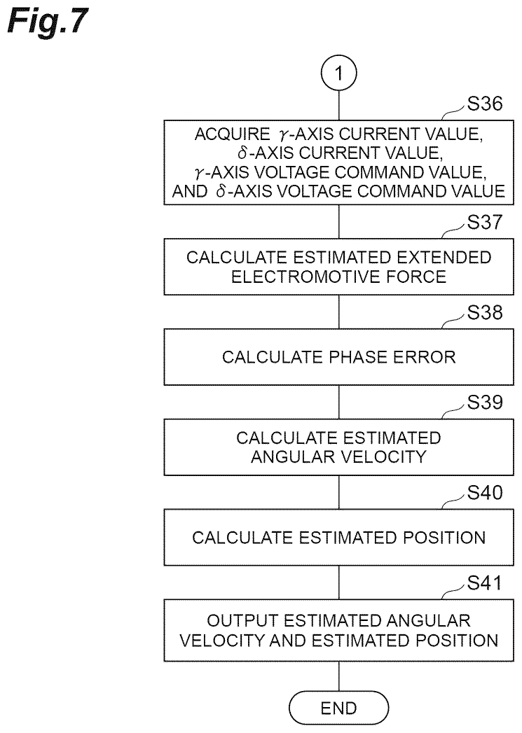

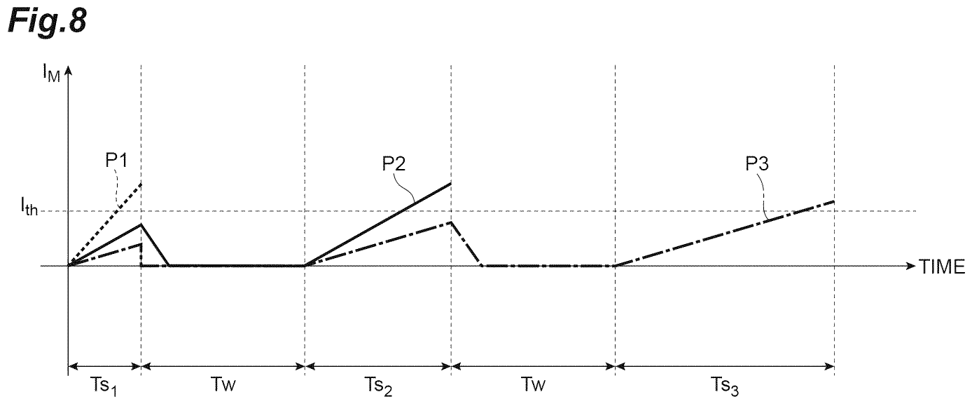

Next, another example of the restart pre-processing performed by the control device 3 will be described in detail with further reference to FIGS. 6 to 8. FIGS. 6 and 7 are flowcharts showing another example of the restart pre-processing performed by the control device of FIG. 1. FIG. 8 is a diagram showing a relationship between a lower arm short-circuit period and a current flowing through a motor.

The increase rate of the current flowing through the motor M in the lower arm short-circuit state is proportional to the rotational speed of the motor M. In other words, the higher the rotational speed of the motor M, the shorter the time required for the current value I_{M} of the current flowing through the motor M to reach the threshold current value Iₜₕ. Therefore, if the lower arm short-circuit period is long, an overcurrent may occur in the motor M rotating at a high speed. On the other hand, the lower the rotational speed of the motor M, the longer the time required for the current value I_{M} to reach the threshold current value Iₜₕ. Therefore, if the lower arm short-circuit period is short, the current value I_{M} of the current flowing through the motor M rotating at a low speed cannot reach the threshold current value Iₜₕ.

In another example of the restart pre-processing, the target range of the rotational speed of the motor M to be restarted from the free-run state is predetermined, and a specified number of times N (N is an integer of 2 or more), which is the number of times the inverter circuit 2 is set to the lower arm short-circuit state, is set. The lower arm short-circuit period Tsₖ (supply period) is set in accordance with the count value k indicating the number of times the process of setting the inverter circuit 2 to the lower arm short-circuit state (lower arm short-circuit processing) is performed. The lower arm short-circuit period Tsₖ is used in the k-th lower arm short-circuit processing. The count value k is an integer of 1 or more and N or less.

Specifically, the lower arm short-circuit period Ts₁ and the lower arm short-circuit period Ts_{N} are set in accordance with the target range. The lower arm short-circuit period Ts₁ is used in the first lower arm short-circuit processing. The lower arm short-circuit period Ts₁ is set to a time slightly longer than the time required for the current value I_{M} of the current flowing through the motor M to reach the threshold current value Iₜₕ at the upper limit rotational speed of the motor M, and during which no overcurrent occurs in the motor M. The lower arm short-circuit period Ts_{N} is used in the N-th lower arm short-circuit processing. The lower arm short-circuit period Ts_{N} is set to a time slightly longer than the time required for the current value I_{M} of the current flowing through the motor M to reach the threshold current value Iₜₕ at the lower limit rotational speed of the motor M, and during which no overcurrent occurs in the motor M.

As the count value k increases, the lower arm short-circuit period Tsₖ gradually increases from the lower arm short-circuit period Ts₁ to the lower arm short-circuit period Ts_{N}. The lower arm short-circuit period Tsₖ is calculated by, for example, Equation (8).

$$[ Equation 8 ]$$

$${Ts}_{k} = {Ts}_{1} + \frac{{Ts}_{N} - {Ts}_{1}}{N - 1} \times ( k - 1 ) \qquad ( 8 )$$

The series of processes shown in FIGS. 6 and 7 is started in response to the control device 3 receiving a restart request. At this time, the count value k is set to 1. As shown in FIG. 6, the control device 3 first controls the switching elements of the upper arms of the three phases included in the inverter circuit 2 to be simultaneously turned off and the switching elements of the lower arms of the three phases to be simultaneously turned on (step S31). In step S31, similarly to step S11, the coordinate conversion unit 54 causes the drive circuit 4 to output the lower arm short-circuit drive signal over the lower arm short-circuit period Tsₖ. In other words, the coordinate conversion unit 54 and the drive circuit 4 supply the lower arm short-circuit drive signal to the inverter circuit 2 over the lower arm short-circuit period Tsₖ. Similarly to step S11, the coordinate conversion unit 54 may cause the drive circuit 4 to output the upper arm short-circuit drive signal instead of the lower arm short-circuit drive signal.

Subsequently, in the lower arm short-circuit period Tsₖ, the arithmetic unit 5 determines whether or not the current value I_{M} of the current flowing through the motor M in response to the lower arm short-circuit drive signal is equal to or greater than the threshold current value Iₜₕ (step S32). As shown in Equation (9), the current value I_{M} is calculated using, for example, the γ-axis current value I_{γ} and the δ-axis current value I_{δ}.

$$[ Equation 9 ]$$

$${I}_{M} = \sqrt{{I}_{γ}^{2} + {I}_{δ}^{2}} \qquad ( 9 )$$

When it is determined in step S32 that the current value I_{M} is less than the threshold current value Iₜₕ (step S32: NO), the arithmetic unit 5 determines whether or not the count value k has reached the specified number of times N (step S33). When it is determined that the count value k has not reached the specified number of times N (step S33: NO), the arithmetic unit 5 (coordinate conversion unit 54) increases the count value k by one, and resets the lower arm short-circuit period Tsₖ according to the increase of the count value k (step S34). After a predetermined waiting period Tw has elapsed, step S31 is executed again.

When it is determined in step S32 that the current value I_{M} is equal to or greater than the threshold current value Iₜₕ (step S32: YES), step S36 is executed. Since steps S36 to S41 are the same as steps S13 to S18, the description thereof will be omitted.

When it is determined in step S33 that the count value k has reached the specified number of times N (step S33: YES), it is considered that the rotational speed of the motor M is below the lower limit rotational speed. Therefore, the arithmetic unit 5 stops the motor M (step S35), and ends the restart pre-processing.

The case where the specified number of times N is set to three times will be described in detail below. As shown in the pattern P1 of FIG. 8, when the rotational speed of the motor M is near the above-mentioned upper limit rotational speed, the current value I_{M} exceeds the threshold current value Iₜₕ in the first lower arm short-circuit processing (lower arm short-circuit period Ts₁), and the processing from step S36 onward is executed. On the other hand, when the current value I_{M} does not reach the threshold current value Iₜₕ in the first lower arm short-circuit processing, the second lower arm short-circuit processing is executed after the waiting period Tw has elapsed.

As shown in the pattern P2 of FIG. 8, when the rotational speed of the motor M is near the middle between the upper limit rotational speed and the lower limit rotational speed, the current value I_{M} exceeds the threshold current value Iₜₕ in the second lower arm short-circuit processing (lower arm short-circuit period Ts₂), and the processing from step S36 onward is executed. On the other hand, when the current value I_{M} does not reach the threshold current value Iₜₕ even in the second lower arm short-circuit processing, the third lower arm short-circuit processing is executed after the waiting period Tw has elapsed.

As shown in the pattern P3 of FIG. 8, when the rotational speed of the motor M is near the lower limit rotational speed, the current value I_{M} exceeds the threshold current value Iₜₕ in the third lower arm short-circuit processing (lower arm short-circuit period Ts₃), and the processing from step S36 onward is executed. On the other hand, when the current value I_{M} does not reach the threshold current value Iₜₕ even in the third lower arm short-circuit processing, it is determined that the rotational speed of the motor M is below the above-mentioned lower limit rotational speed, and the motor M is stopped.

In the restart pre-processing shown in FIGS. 6 and 7, the same effects as those of the restart pre-processing shown in FIG. 3 can be obtained in the configuration common to the restart pre-processing shown in FIG. 3. The coordinate conversion unit 54 supplies the lower arm short-circuit drive signal to the inverter circuit 2 over the lower arm short-circuit period Tsₖ. In order to calculate the estimated position θ^{\hat{ }}ᵣₑₗ, a current value I_{M} of a certain magnitude is required. Therefore, the estimation unit 55 calculates the estimated position θ^{\hat{ }}ᵣₑₗ when the current value I_{M} becomes equal to or greater than the threshold current value Iₜₕ during the lower arm short-circuit period Tsₖ. Therefore, since the estimated position θ^{\hat{ }}ᵣₑₗ is calculated when a certain amount of current flows through the motor M, the accuracy of the estimated position θ^{\hat{ }}ᵣₑₗ can be further improved.

The lower arm short-circuit period Tsₖ becomes gradually longer. Therefore, it is possible to allow a certain amount of current to flow through the motor M rotating at a low speed while reducing the possibility of an overcurrent occurring in the motor M rotating at a high speed. As a result, it is possible to expand the range of the rotational speed of the motor M in which the position can be estimated.

While the embodiments of the present disclosure have been described in detail, the control device according to the present disclosure is not limited to the above-described embodiments.

In the above embodiments, the position estimation of the motor M is performed in the restart pre-processing, but is not limited thereto. When the motor M is rotating at a low speed, step S11 or step S19 may be executed, and the position of the motor M may be estimated based on the current value I_{M} flowing through the motor M by executing step S11 or step S19. That is, the arithmetic unit 5 determines whether or not the motor M is rotating at a low speed, and when it is determined that the motor M is rotating at a low speed, the flow of FIG. 3 may be executed, or step S19 and steps S13 to S18 may be executed in order. For example, the arithmetic unit 5 determines that the motor M is rotating at a low speed when the current value I_{M} flowing through the motor M is less than the threshold current value Iₜₕ. When the position of the motor M is estimated while the motor M is rotating at a low speed, the S/N ratio deteriorates, which may result in a decrease in the accuracy of position estimation. On the other hand, by executing step S19, the voltage error can be eliminated, and the accuracy of the position estimation can be improved.

### REFERENCE SIGNS LIST

2 . . . inverter circuit (inverter), 3 . . . control device, 4 . . . drive circuit (drive signal output unit), 51 . . . coordinate conversion unit (current value conversion unit), 52 . . . γ-δ current command value output unit, 53 . . . δ-δ voltage command value calculation unit, 54 . . . coordinate conversion unit (drive signal output unit), 55 . . . estimation unit, M . . . motor, SW1 to SW6 . . . switching elements.

1. A control device configured to generate a drive signal for controlling an inverter that drives a motor, the control device comprising:
a current value conversion unit configured to convert a current flowing through the motor into a γ-axis current value and a δ-axis current value;
a γ-δ current command value output unit configured to output a γ-axis current command value and a δ-axis current command value;
a γ-δ voltage command value calculation unit configured to calculate a γ-axis voltage command value and a δ-axis voltage command value based on the γ-axis current value, the γ-axis current command value, the δ-axis current value, and the δ-axis current command value;
a drive signal output unit configured to convert the γ-axis voltage command value and the δ-axis voltage command value into the drive signal and output the drive signal to the inverter; and
an estimation unit configured to calculate an estimated extended electromotive force, which is an estimated value of an extended electromotive force generated in the motor, based on the γ-axis current value, the δ-axis current value, the γ-axis voltage command value, and the δ-axis voltage command value, and to calculate an estimated position, which is an estimated value of a position of the motor, based on the estimated extended electromotive force,
wherein the drive signal output unit is configured to generate, when a restart request is received or when it is determined that the motor is rotating at a low speed, an upper arm short-circuit drive signal, which is the drive signal that simultaneously turns on switching elements of upper arms of three phases in the inverter and simultaneously turns off switching elements of lower arms of the three phases in the inverter, or a lower arm short-circuit drive signal, which is the drive signal that simultaneously turns off the switching elements of the upper arms of the three phases in the inverter and simultaneously turns on the switching elements of the lower arms of the three phases in the inverter, and
wherein the estimation unit is configured to calculate the estimated position based on the γ-axis current value and the δ-axis current value converted from the current flowing through the motor by the upper arm short-circuit drive signal or the lower arm short-circuit drive signal, after setting estimated angular velocity and the estimated position to zero.

2. The control device according to claim 1,
wherein the estimation unit calculates the estimated extended electromotive force by Equation (1), in which a γ-axis estimated extended electromotive force is denoted as e^{\hat{ }}_{γ}, a δ-axis estimated extended electromotive force is denoted as e's, the γ-axis voltage command value is denoted as V*_{γ}, the δ-axis voltage command value is denoted as V*_{δ}, an estimated winding resistance is denoted as R^{\hat{ }}, a d-axis estimated inductance is denoted as L^{\hat{ }}_{d}, a q-axis estimated inductance is denoted as L^{\hat{ }}_{q}, the estimated angular velocity is denoted as ω^{\hat{ }}ᵣₑ, the γ-axis current value is denoted as I_{γ}, the δ-axis current value is denoted as I_{δ}, and a differential operator is denoted as p, and
wherein the estimation unit calculates the estimated extended electromotive force by setting V*_{γ}=V*_{δ}=0 and ω^{\hat{ }}ᵣₑ=0 in Equation (1) when the restart request is received or when it is determined that the motor is rotating at a low speed.
$$[ Equation 1 ]$$
$$[ \begin{matrix}{\hat{e}}_{γ} \\ {\hat{e}}_{δ}\end{matrix} ] = [ \begin{matrix}{V}_{γ}^{*} \\ {V}_{δ}^{*}\end{matrix} ] - [ \begin{matrix}\hat{R} + p {\hat{L}}_{d} & {\hat{ω}}_{re} {\hat{L}}_{q} \\ {\hat{ω}}_{re} {\hat{L}}_{q} & \hat{R} + p {\hat{L}}_{d}\end{matrix} ] [ \begin{matrix}{I}_{γ} \\ {I}_{δ}\end{matrix} ] \qquad ( 1 )$$

3. The control device according to claim 2,
wherein when the restart request is received, the estimation unit:
calculates a first estimated extended electromotive force by setting V*_{γ}=V*_{δ}=0 and ω^{\hat{ }}ᵣₑ=0 in Equation (1);
calculates a first estimated position based on the first estimated extended electromotive force;
in response to a predetermined time having elapsed from calculating the first estimated position, calculates a second estimated extended electromotive force by setting V*_{γ}=V*_{δ}=0 and ω^{\hat{ }}ᵣₑ=0 in Equation (1);
calculates a second estimated position based on the second estimated extended electromotive force; and
calculates the estimated angular velocity based on the first estimated position and the second estimated position.

4. The control device according to claim 1,
wherein the drive signal output unit supplies the upper arm short-circuit drive signal or the lower arm short-circuit drive signal to the inverter over a supply period, and
the estimation unit calculates the estimated position when a motor current value of the current flowing through the motor becomes equal to or greater than a threshold current value in the supply period.

5. The control device according to claim 4,
wherein the drive signal output unit extends the supply period in stages when the motor current value is less than the threshold current value in the supply period.

6. A control device configured to generate a drive signal for controlling an inverter that drives a motor, the control device comprising:
a current value conversion unit configured to convert a current flowing through the motor into a γ-axis current value and a δ-axis current value;
a γ-δ current command value output unit configured to output a γ-axis current command value and a δ-axis current command value;
a γ-δ voltage command value calculation unit configured to calculate a γ-axis voltage command value and a δ-axis voltage command value based on the γ-axis current value, the γ-axis current command value, the δ-axis current value, and the δ-axis current command value;
a drive signal output unit configured to convert the γ-axis voltage command value and the δ-axis voltage command value into the drive signal and output the drive signal to the inverter; and
an estimation unit configured to calculate an estimated extended electromotive force, which is an estimated value of an extended electromotive force generated in the motor, based on the γ-axis current value, the δ-axis current value, the γ-axis voltage command value, and the δ-axis voltage command value, to calculate an estimated position, which is an estimated value of a position of the motor, based on the estimated extended electromotive force, and to calculate an estimated angular velocity of the motor based on the estimated position,
wherein the drive signal output unit is configured to generate, when a restart request is received, an upper arm short-circuit drive signal, which is the drive signal that simultaneously turns on switching elements of upper arms of three phases in the inverter and simultaneously turns off switching elements of lower arms of the three phases in the inverter, or a lower arm short-circuit drive signal, which is the drive signal that simultaneously turns off the switching elements of the upper arms of the three phases in the inverter and simultaneously turns on the switching elements of the lower arms of the three phases in the inverter,
wherein the estimation unit is configured to calculate a first estimated position, which is the estimated position, based on the γ-axis current value and the δ-axis current value converted from the current flowing through the motor by the upper arm short-circuit drive signal or the lower arm short-circuit drive signal, after setting the estimated angular velocity and the estimated position to zero,
wherein the drive signal output unit is configured to generate the upper arm short-circuit drive signal or the lower arm short-circuit drive signal again after calculating the first estimated position, and
wherein the estimation unit is configured to calculate a second estimated position, which is the estimated position, based on the γ-axis current value and the δ-axis current value converted from the current flowing through the motor by the upper arm short-circuit drive signal or the lower arm short-circuit drive signal generated again, after setting the estimated angular velocity and the estimated position to zero, and to calculate the estimated angular velocity based on the first estimated position and the second estimated position.
